(19) United States
(12) Patent Application Publication
(10) Pub. No.: US 2010/0306188 A1
(43) Pub. Date: Dec. 2, 2010

(54) PERSISTENT QUERY PLANS

(75) Inventors: Conor Cunningham, Austin, TX (US); Boris Baryshnikov, Redmond, WA (US); Xiaowei Jiang, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/475,610

(22) Filed: Jun. 1, 2009

(51) Int. Cl. G06F 17/30

(52) U.S. Cl. 707/713; 707/769; 707/736; 707/770

(57) ABSTRACT

A system and method for processing database queries. An optimizer produces query plans based on queries. Query plans are stored in a persistent storage. In response to receiving a query, the system selectively retrieves a stored query plan corresponding to the query for execution. Optimization of the query may be selectively performed. A stored query plan or a new query plan may be executed. Based on metrics collected during execution, the system may automatically revert to a stored plan other than the one being executed. Based on metrics of a reverted to plan, the system may roll back to the first plan. The persistent storage enables the use of query plans after a system restart, transfer to another device, or other changes.

### TECHNICAL FIELD

The present invention relates generally to data processing systems, and, more particularly, to the storage and reuse of query plans.

### BACKGROUND

SQL (Structured Query Language) is a declarative language. An SQL query indicates what operations are to be performed, but it does not specify how they are to be performed. Relational database systems typically include a compilation process that translates a query into a query plan. A query optimizer, which performs part of the compilation process, attempts to determine an efficient procedural plan that can be used to perform the desired query. The optimizer may generate a number of possible query plans, evaluate each one, and select one based on the execution costs of each plan.

The process of query optimization may consume a large amount of processor time for complex queries. The task is complicated by the difficulty of evaluating the cost of a potential plan. Cost-based optimization uses statistics from the target data set, such as the number of rows or columns in a table or the number of rows matching a particular value, and evaluates the cost of a potential plan based on this data. The generation of query plans may be non-deterministic, and running the same query multiple times may result in the generation of different query plans with widely different results. Some database systems employ a volatile query plan cache to find a previously generated query plan for use with a query. Upon receiving a query, a query processor may search the cache for a matching query plan. If one is found, this may be reused instead of having the optimizer generate a new plan. A plan that is in a cache may be invalidated under certain conditions, such as a significant change in the number of rows, a system restart, a system version update, or other conditions.

A query processor does not always make the optimal decisions when determining a query plan to use, whether this decision is made when producing a new query plan or determining whether to use a plan from a query plan cache. A query that is processed multiple times may have varied results with respect to the time of performing the query. A query plan that performs well in one execution may perform poorly in a subsequent execution, due to changes to the database or system configuration changes. Results of repeat queries do not always improve with each iteration.

Some techniques for reducing the work of a query optimizer are call directed optimization techniques. For example, a query hint may be submitted with a query. The query hint attempts to direct the query optimizer to generate a particular query plan. This may be used if an existing plan is satisfactory, and an administrator wants a similar query to use the same plan or one similar.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to facilitate database queries. In an example embodiment, a system compiles queries to produce corresponding query plans. The query plans may be stored in a persistent storage. In response to receiving a new query, a stored query plan may be designated as a first query plan to execute. The new query may be compiled to produce a new query plan. If a new query plan is produced, the new query plan may be designated as the first query plan to execute. The designated query plan may be executed. Metrics associated with the execution of the designated query plan may be collected. In one embodiment, a determination is automatically made of whether to revert to a second query plan and execute the second query plan, based on the collected metrics. In one embodiment, a determination is automatically made of whether to roll back to the first query plan and execute the first query plan, based on the execution of the second query plan.

In one embodiment, after storing query plans in the persistent storage, the system may be restarted, the computing device rebooted, or portions of the system may be transferred to a second computing device. After restarting, rebooting, or transferring, the stored query plans may continue to be used on the restarted or second computing device; a stored query plan may be designated as the first query plan.

In one embodiment, in response to a query processing system being updated with a new version, stored query plans are updated to conform to the new version. This may include changing the format

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of an example environment in which embodiments may be practiced;

FIG. 2 is a block diagram of an example query processing system that may be employed in some embodiments;

FIGS. 3A-B are flow diagrams of processes of processing an SQL query, in accordance with an example embodiment;

FIG. 4 is a flow diagram illustrating a process of executing an SQL query, in an example embodiment;

FIG. 5 is a flow diagram illustrating a process of using stored query plans in a changed context, in an example embodiment; and

FIG. 6 is a block diagram illustrating an example embodiment of a computing system that may be employed to implement a data server or query processing system.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “pointer” refers to a reference to a target physical or logical memory location, data structure, program instruction, or program segment. A pointer “points to” a target and may be used to locate or obtain the target. A pointer may be implemented in a variety of ways, including an address, an offset, an index, or an identifier. It may be used to identify or locate a node of a graph structure.

As used herein, the terms “latch” and “latching” refer to a mechanism to control access to data. More specifically, latches are used to assure physical consistency of data. This is distinguished from locks, which are used to assure logical consistency of data. A latch may be used, for example, to control access to a physical page of memory, or a data structure.

As used herein, the term “administrator” refers to any person who maintains, controls, or otherwise interacts with a query processing system or any components described herein.

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

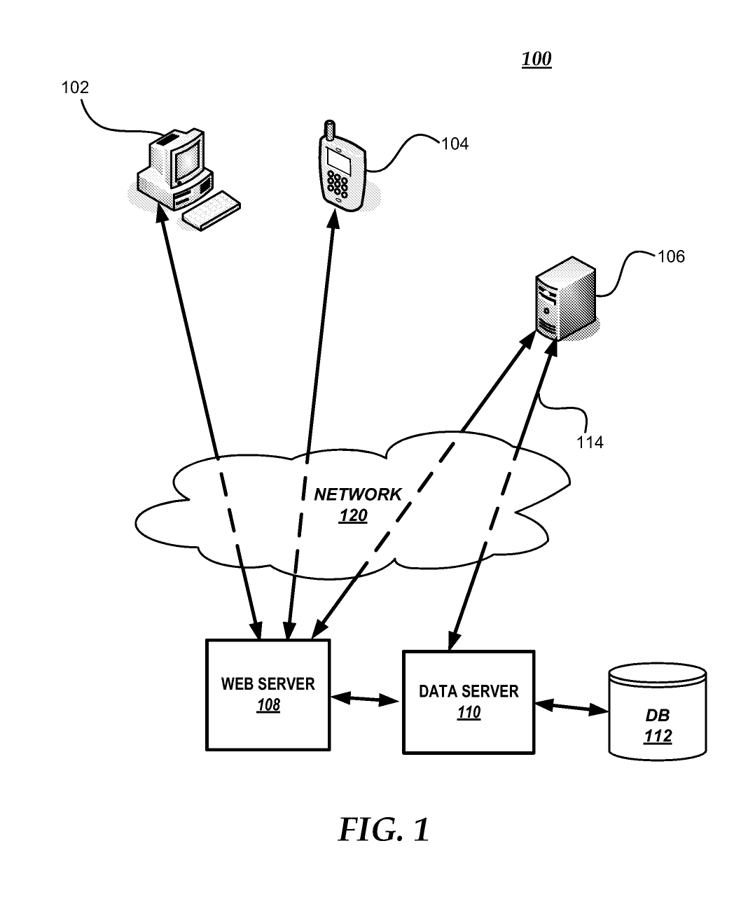

FIG. 1 is a block diagram of an example environment 100 in which embodiments may be practiced. FIG. 1 provides a basic understanding an example environment, though many configurations may be employed and many details are not illustrated in FIG. 1. As illustrated in FIG. 1, an example environment 100 includes clients 102, 104, and 106. Each of clients 102-106 may be a client computing device, process, or any component that requests access to stored data. In the example embodiment, client 102 is illustrated as a personal computer, client 104 is illustrated as a mobile communication device, and client 106 is illustrated as a server, in order to show the variety of clients that may exist. Other computing devices or processes may be clients in various environments.

Example environment 100 includes Web server 108. Web server 108 may be a computing device, server, or a server farm that includes multiple servers, or a process executing thereon. Web server 108 may receive requests from each of clients 102-106, perform actions, and respond to the requests. In various embodiments, Web server 108 may maintain a Web site, an email service, a messaging service, or provide any of various other services.

In the illustrated example environment, Web server 108 communicates with data server 110. Data server 110 may be a computing device, server, or a server farm that includes multiple servers, or a process executing thereon. Data server 110 may have an associated storage device 112, in which data is stored. Storage device 112 may include one or more disk drives, flash memory, optical storage mechanisms, or any other type of non-volatile memory. Storage device 112, or a portion thereof, may be external to data server 110 or integrated with it.

Each of clients 102-106 may communicate with Web server 108 through direct connections or a network 120. Network 120 may include a local area network, a wide area network, or a combination thereof. In one embodiment, network 120 includes the Internet, which is a network of networks. Network 120 may include wired communication mechanisms, wireless communication mechanisms, or a combination thereof. Communications between clients 102-106 and Web server 108, with each other or other computing devices may employ one or more of various wired or wireless communication protocols, such as IP, TCP/IP, UDP, HTTP, SSL, TLS, FTP, SMTP, WAP, Bluetooth, or WLAN.

As illustrated by arrow 114, any client, such as client 106, may communicate directly with data server 110. This may include sending requests to, and receiving responses from, data server 110. Web server 108 may communicate with data server 110 directly or through a network, such as network 120. Web server 108 may be considered to be a client sending requests to data server 110.

In one example configuration, any one of clients 102-106 may send a request for data to Web server 108. In response, Web server 108 may send a query to data server 110. Data server 110 performs actions to access data, which may be stored on storage device 112. Data server 110 may then send a response to Web server 108, which sends its response, based on the data server's response, to the client. Various other processes may occur in environment 100 or variations thereof. As discussed, client 106 may send a query directly to data server 110. In one configuration, Web server 108 may send a request to data server 110 that is not triggered by a client request. In some configurations, a client may reside on the same device as Web server 108 or even on the same device as data server 110, and send requests to data server 110.

FIG. 1 is only an example of a suitable environment and is not intended to suggest any limitation as to the scope of use or functionality of the present invention. Thus, a variety of system configurations may be employed without departing from the scope or spirit of the present invention. For example, any of the functions of Web server 108 or data server 110 may be combined into one or more computing devices, distributed, or replicated among multiple computing devices in a variety of ways.

In one embodiment, each of clients 102-106, Web server 108, and data server 110 is implemented by one or more computing devices. A computing device may be a special purpose or general purpose computing device. In brief, one embodiment of a computing device that may be employed includes one or more processing units, a memory, a display, keyboard and pointing device, and a communications interface. The one or more processing units may include one or more single or multiple core processors. Example computing devices include mainframes, servers, blade servers, personal computers, portable computers, communication devices, consumer electronics, or the like. A computing device may include a general or special purpose operating system. The Windows® family of operating systems, by Microsoft Corporation, of Redmond, Wash., are examples of operating systems that may execute on a computing device of a development system.

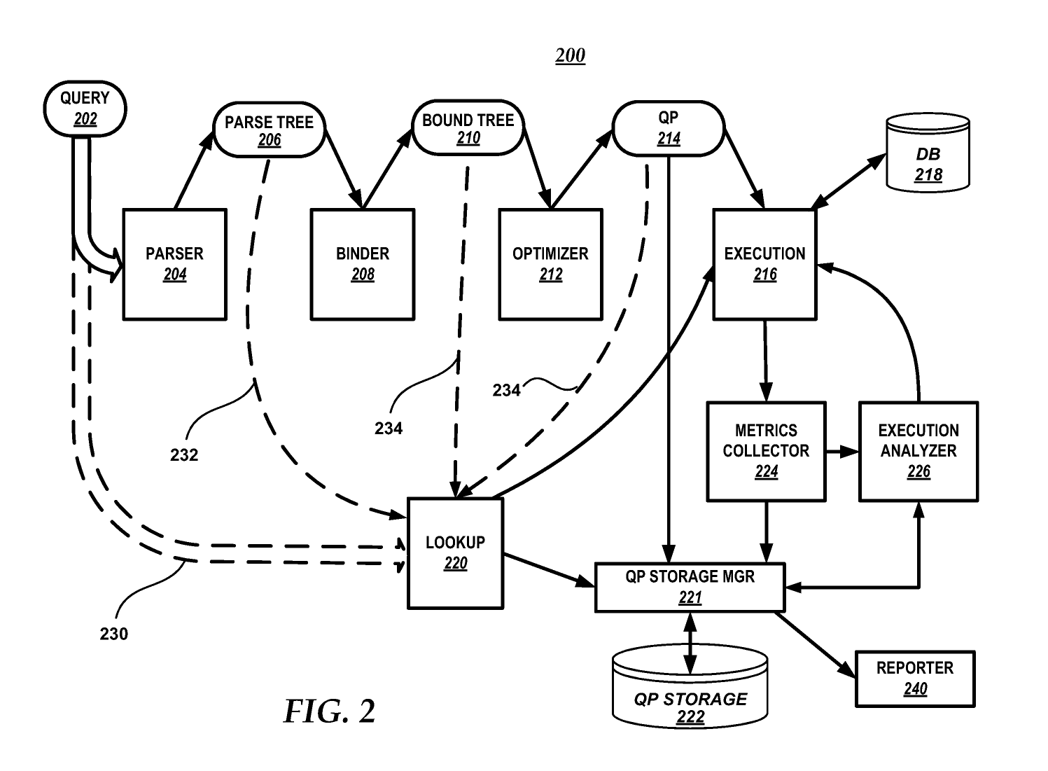

FIG. 2 is a block diagram of an example query processing system 200 that may be employed in some embodiments. In the illustrated embodiment, query processing system 200 includes parser 204, binder 208, optimizer 212, and execution component 216. In one implementation, parser 204 receives a query, such as SQL query 202, parses the query, and generates parse tree 206. Parse tree 206 is a tree representation of SQL query 202, in which operations are described logically. It may represent operations indicated by SQL query 202, but not the order of operations.

In one embodiment, binder 208 converts parse tree 206 into bound tree 210. Binder 208 may analyze the syntax and semantics of the query represented by parse tree 206. Binder 208 may eliminate redundant data, resolve names of tables, columns, and variables and bind them to corresponding objects in the database. A bound tree is sometimes referred to as a normalized tree. Parse tree 206 and bound tree 210 each are representations of query 202. As used herein, the term “query” may refer to an SQL query 202 or the corresponding representations as parse tree 206 or bound tree 210, unless clearly distinguished by the context.

In one embodiment, optimizer 212 converts bound tree 210 into query plan 214, also referred to as a query execution plan, or simply a “plan.” A query plan includes a series of instructions that indicate how a query is to be executed. This may include the operations to be performed and the ordering of the operations. For example, when joining multiple tables, the query plan indicates the join order and join method to be used. A query plan may also indicate which, if any, indexes to use, an order in which constraints are to be applied, or other specifications. A query plan may be limited by the features implemented by execution component 216. Query plan 214 may be in a binary format.

Optimizer 212 may generate many candidate query plans based on bound tree 210 and determine one that it considers to be the lowest cost plan. The determined plan is produced as query plan 214. Speed of execution is typically the greatest factor in the determination of a plan's cost. Query optimizer 212 may include a number of heuristics that are used to determine a lowest cost query plan from numerous possibilities, based on configured criteria, heuristics employed, and available data. Optimizer 212 may use configuration data in determining a candidate query plan to be produced. In one embodiment, optimizer 212 retrieves metrics or other data from QP storage 222 to determine the plan to produce. In one embodiment, optimizer 212 may determine a candidate plan that matches a stored query plan, or one that does not match a stored query plan, based on data corresponding to the stored query plans. The actions of parser 204, binder 208, and optimizer 212, or a portion thereof, are referred to as “compilation” of an SQL query.

Execution component 216 may receive query plan 214 and execute it. Execution may include retrieving data from database 218 and returning a set of results. It may also include modifying data in database 218. As used herein, execution of a query plan refers to execution of the complete query plan or a portion thereof. Thus, “executing” a query plan may refer to executing a portion of the query plan.

The illustrated embodiment of query processing system 200 also includes query plan (QP) storage 222, QP storage manager 221, lookup component 220, metrics collector 224, and execution analyzer 226. In one implementation, query plans 214 that are produced by optimizer 212 are stored in QP storage 222. In various implementations, this may include all such query plans, or a subset thereof. For example, in one implementation, query plans to be stored in QP storage 222 are selected based on the likelihood of the query being reused, how recent the query or a similar one had been processed, or other factors. In one embodiment, QP storage 222 is maintained in a non-volatile storage, referred to as a “persistent” store.

In one embodiment, QP storage manager 221 stores data to, retrieves data from, and maintains the query plans and other data in QP storage 222. QP storage manager 221 may serve as an interface to QP storage 222 for other components described herein. Though illustrated as a distinct component in FIG. 2, in some implementations, portions of QP storage manager 221 may be integrated with any other components that store, retrieve, or manipulate data in QP storage 222.

Storage of a query plan may include storing one or more representations of the corresponding query. The original query 202, the parse tree 206, bound tree 210, or any combination of these representations may be stored and associated with the corresponding query plan, to facilitate searching for a query plan based on a query.

Lookup component 220 may be used to reduce the use of optimizer 212 to process some queries. In various embodiments, lookup component 220 may receive a query in the form of SQL query 202, parse tree 206, or bound tree 210, as indicated by dashed arrows 230, 232, and 234, respectively. Lookup component 220 may search QP storage 222 and determine whether one or more stored query plans match the current query. If more than one such query plan exists, lookup component 220 may determine which of the query plans is the lowest cost query plan. If only one such plan is found, then it is considered the lowest cost plan. It may determine whether to use the lowest cost plan, or to allow the query to be submitted to optimizer 212 to produce a new query plan.

As used herein, a query plan that is produced from a first query may “match” a second query, if the second query is identical or equivalent to the first query. In some embodiments, there may be a match if the second query is similar enough to the first query to allow the query plan to be used for the second query, though a modification of the query plan may be performed. In one embodiment, a query plan may be parameterized, enabling it to be used for similar queries that differ in a parameter field.

In one embodiment, the cost of a plan is based on speed of execution of the plan. In various embodiments, one or more other factors may be considered. Other factors may include overall system throughput, locking behavior of the query, or structure of the query. Another possible factor is the quantity or type of resources allocated, such as processors, threads, or memory. In one embodiment, query stability may be a factor in determining cost. For example, a particular plan may have an average latency that is lower than other plans, but may be highly variable, for example, based on environmental factors or whether a certain threshold is reached. This may be considered to be a high cost, and a plan with a higher average latency may be preferable.

If lookup component determines that a query plan from QP storage is to be used, it may submit the plan to execution component 216. If it determines that a new query plan is to be produced, it may allow the processing of the query to continue, as described above, so that optimizer 212 produces a new query plan. Use of a stored query plan may thus avoid the actions of optimizer 212 for the current query. In various implementations, it may also avoid the actions of binder 208 or parser 204, depending on which of these components processed the query prior to submitting it to lookup component 220.

In one embodiment, lookup component 220 may receive and process a query plan 214 after it is produced by optimizer 212, as indicated by dashed arrow 236. A query plan 214 that is the most recent query plan produced by optimizer 212 for a specific SQL query 202 is referred to as the “default” query plan. The default query plan changes with each subsequent optimization of the SQL query, unless the same query plan is produced. Lookup component 220 may search QP storage 222 for one or more matching plans, as discussed above, and compare the lowest cost plan that is found with the default query plan 214. It may thus determine whether to use the default query plan 214 or a previously stored query plan, designate the determined plan as the plan to execute, and provide the designated plan to execution component 216.

There are therefore a number of ways that lookup component 220 and query processing system 200 may operate for a particular query. One is to search for a stored plan; if a satisfactory plan is found, execute the determined plan without producing a new query plan. Another technique is to optimize the query to produce a new query plan, search for a stored plan and compare the lowest cost stored plan with the new query, designating the one that is determined to be better as the plan to execute.

In one embodiment, metrics collector 224 may perform actions to retrieve metrics corresponding to executed or executing query plans. For a particular query plan, the metric data may include one or more of the execution time of a query plan or a portion thereof, the processor time, a quantity of resources used, or a timestamp. The metric data may include statistics relating to the database, such as quantities of rows retrieved by each operation, table sizes, or the like. The metric data may also include data relating to the system configuration or environment, such as an amount of memory, system version identifier, system load, or the like. Aggregate metrics, such as average times for a group of executions, may be computed and stored. Metrics may be retrieved during execution of a query plan, based on execution of a portion of the plan, though these metrics are not necessarily stored in QP storage 222.

Metrics collector 224 may store the metrics in QP storage 222 in a format that enables efficient retrieval of metrics corresponding to a query plan. The metrics may be stored in a way that facilitates retrieval of metrics based on age, database statistics, configuration, environment, or other specifications. In one implementation, metrics data may be segmented into buckets, in which a bucket is based on the age of each metric, an amount of data, a number of execution events, or the similarity of metrics data. A bucket is a logical grouping of items. Age may be measured in units of time, quantities of queries, database changes, or another metric. In one implementation, buckets beyond a specified age may be merged into a combined historical bucket, thereby limiting the total number of buckets.

In one embodiment, lookup component 220 may retrieve metrics data from QP storage corresponding to each plan retrieved. The metrics data may be used to make determinations as to which query plan is the lowest cost plan. The metrics data may also be used to make a determination of whether to perform an optimization of a current query or to use a stored plan. For example, a configured threshold may be used to distinguish between queries for which a new query plan is to be produced and queries for which a stored query plan is to be used without performing a new optimization.

In one embodiment, lookup component 220 may make its determinations based on age of the metrics data. For example, in one implementation, metrics data from the one or more of the most recent buckets, where buckets are based on age, may be employed. A determination may be biased toward fresher metrics data in a variety of ways. For example, fresher metrics data may be weighted more than older metrics data. The number of buckets to use, or the quantity of metrics data to use may be based on other factors, such as configuration, environment, or database statistics. For example, if a database table size increases beyond a threshold, metrics may be selectively used based on whether they are similar to the current table size. Metrics may also be selectively used based on system configuration or environmental data.

In one embodiment, execution analyzer 226 performs actions to analyze the execution of a query plan. The query plan may be one that was retrieved from QP storage, as described herein, or a query plan 214 that was received from optimizer 212 as part of processing a current SQL query 202. Analysis may be performed concurrently with the plan execution or after the plan execution completes. Execution analyzer 226 may retrieve metrics from metrics collector 224, QP storage 222, or another source. In one embodiment, during execution of a query, execution analyzer 226 retrieves metrics relating to a partial execution. An example of such metrics may include execution times for performing one or more operations of the query plan.

Based on these metrics, execution analyzer may evaluate the executing query plan to determine whether it is sufficient to continue the execution, whether to change to the use of a stored plan, or whether another type of change action should be performed. The actions may include determining an estimate of a completed execution time, based on the metrics of the partial execution. The actions may include comparing the metrics with expectations of the metrics. This may include expectations that are used by optimizer 212 when determining a query plan. If these expectations are significantly incorrect, it may be an indication that the complete execution will be significantly higher than expected.

The actions of execution analyzer 226 may include comparing the executing query plan with one or more stored plans to determine the plan with the lowest cost. In one embodiment, the execution of the new query plan may be continued, even if a stored plan is determined to have a lower cost. For example, there may be a configured threshold of a difference that is to be reached in order to determine that an executing query plan is to be replaced. The threshold may vary based on a percentage of the query that has already completed or an estimated time to completion. In one embodiment, if the total execution time is below a configured threshold, the new execution may be continued.

Based on the configuration, the metrics data, or other factors, execution analyzer may determine that the current execution is to be stopped and replaced with execution of a query plan retrieved from QP storage 222. This is referred to herein as “reverting” the executing query plan. Reverting a query plan may include retrieving a stored query plan that is determined to have the lowest cost and sending this query plan to execution component 216.

In one implementation, if an executing plan is reverted, the plan is marked in QP storage 222 as having been reverted. In subsequent processing of an equivalent SQL query 202, lookup component 220 may consider whether a plan has been reverted when determining a lowest cost plan. It may also consider whether the most recently produced query plan for an equivalent SQL query has been reverted, when determining whether to allow optimizer 212 to produce a new query plan 214. The age of the most recent such query plan may also be considered. For example, if a recent query plan was reverted, this may be an indication that it is not worth producing a new query plan, there being a high likelihood that it will not be significantly better than the prior such query plan.

In one embodiment, optimizer 212 may use data on reverting to produce a query plan. If the reverted query plan is the default query plan, in a subsequent optimization of the corresponding query, the optimizer may avoid producing an identical query plan, or otherwise produce a query plan based on this data. This technique may also be applied if the reverted query plan is the most recently produced and stored query plan corresponding to the query. Thus, at least some of the mechanisms described herein may be used to automatically tune optimizer 212.

In one embodiment, execution analyzer 226 may perform operations with metrics or reversion data such as those described above even after a query execution has completed. This may include storing the analysis data in QP storage for use by lookup component 220 or execution analyzer 226 with a subsequent query.

It is to be noted that lookup component 220 and execution analyzer 226 perform similar or equivalent actions. In various embodiments, these two components may be integrated into one component or share a common library. In various embodiments, any of the actions described with respect to one or these components may be performed by the other.

In one embodiment, query processing system 200 includes reporter 240, which receives stored query plans, corresponding queries, and associated metrics from QP storage 222. Reporter 240 may analyze this information and produce a report. A produced report may show trends or historical changes to query plans for a specified query, for a set of related queries, or for another set of queries. A report may indicate, for a specified query plan, one or more correlations with database, system, or environment data. For example, a query plan may have the lowest cost in normal circumstances, but have a high degradation when the system is heavily loaded. The reports may be used, for example, by an administrator to debug, tune or configure query processing system 200. Configuration changes may include configurations of optimizer 212 that direct selections of query plans or a configuration of database 218 to facilitate lower cost data access.

In one embodiment, parser 204, binder 208, optimizer 212, execution component 216, lookup component 220, metrics collector 224, and execution analyzer 226, or a subset thereof, may reside within data server 110, of FIG. 1. QP storage 222 may also reside on data server 110 or on a separate device. In one embodiment, QP storage 222 may be integrated with database 218.

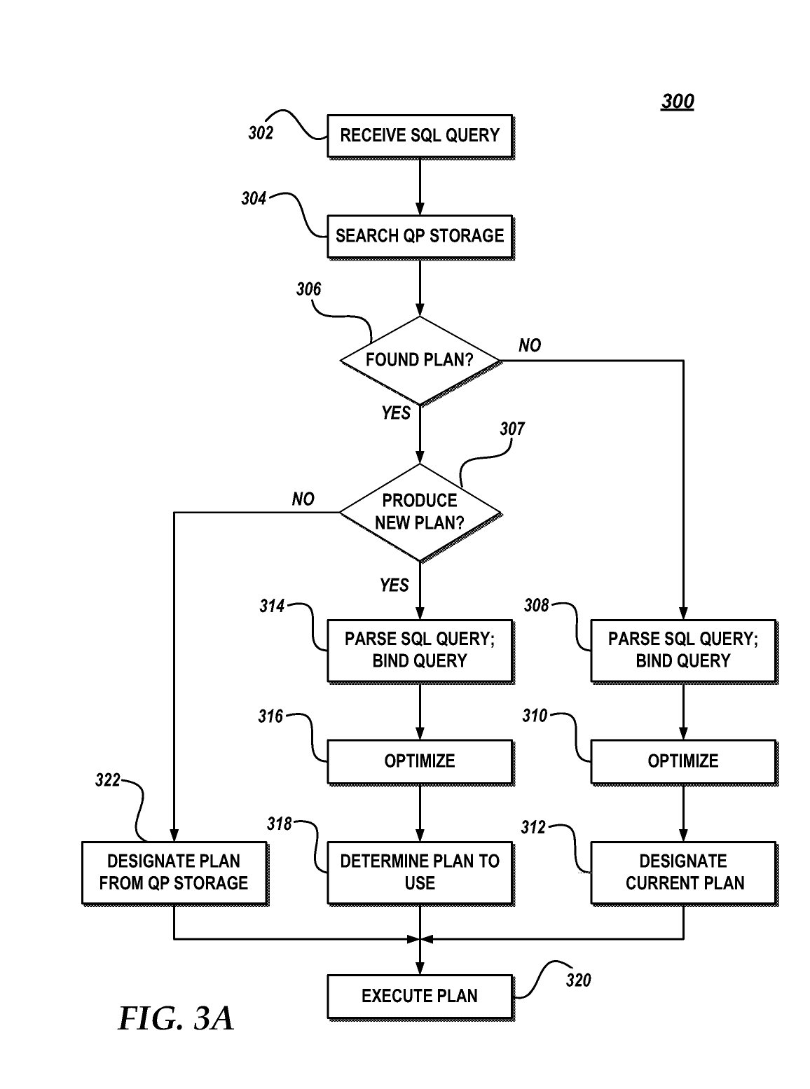

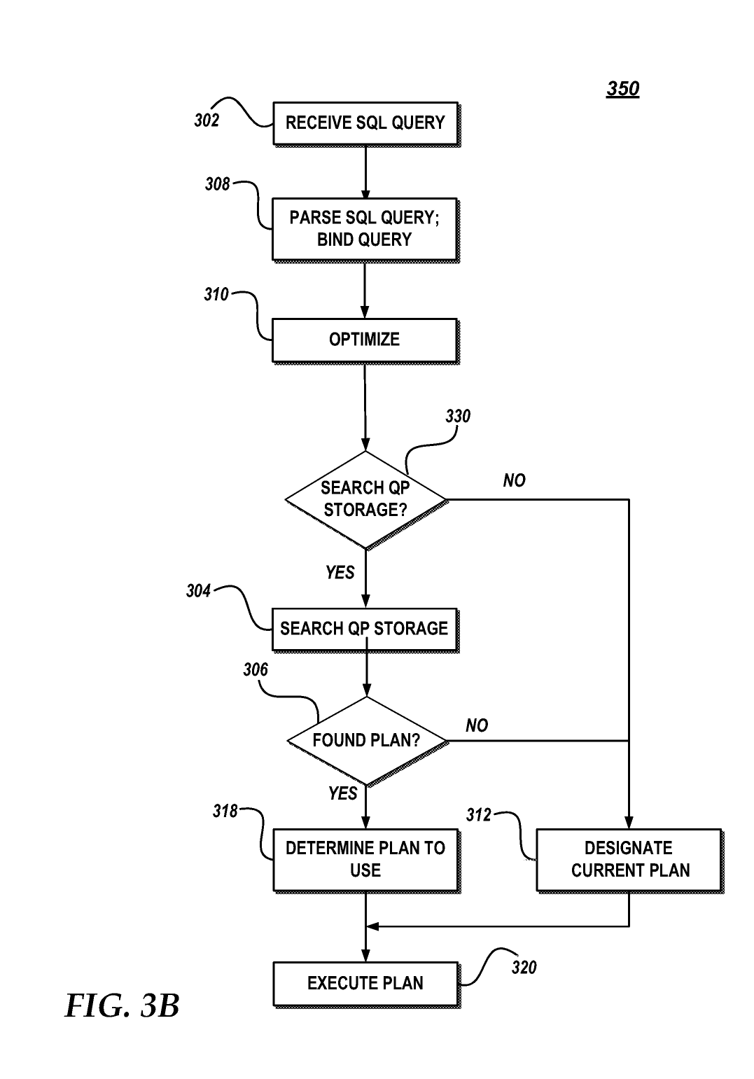

FIG. 3A is a flow diagram of a process 300 of processing a query, in an example embodiment. In one embodiment, at least a portion of the actions of process 300 are performed by query processing system 200, or components thereof.

The illustrated portions of process 300 may be initiated at block 302, where an SQL query 202 may be received. The SQL query and various representations thereof are referred to as the “new” query. The process may flow to block 304, where a search of QP storage 222 may be performed. As discussed herein, this may include determining whether one or more stored query plans match the new query. It may also include, if there is more than one matching query, determining a lowest cost query plan. The actions of block 304 may include retrieving the found plan, if there is one.

The process may flow to decision block 306, where a determination is made of whether at least one matching query plan was found that is sufficient to satisfy configured criteria. If at least one such plan is not found, the process may flow to block 308, where compilation of the new query may begin. The actions of block 308 may include parsing the SQL query to produce a parse tree, such as parse tree 206, and binding the parse tree to produce a bound tree, such as bound tree 210. The process may flow to block 310, where optimization of the bound tree is performed to produce a query plan. This query plan is referred to as the “new” query plan. The process may flow to block 312, where the new query plan is designated as the query plan to execute. The process may flow to block 320, where the designated query plan is executed.

If, at block 306, it is determined that at least one sufficient query plan was found in QP storage 222, the process may flow to decision block 307, where a determination is made of whether to produce a new query plan based on the new query. If it is determined to produce a new query plan, the process may flow to block 314. At block 314, the actions of block 308 may be performed, including parsing the SQL query to produce a parse tree and binding the parse tree to produce a bound tree. The process may flow to block 316, where optimization of the bound tree is performed to produce a query plan. This query plan is referred to as the “new” query plan. The process may flow to block 318, where a determination is made of whether to use the new query plan or the stored query plan found and determined to be the lowest cost query plan at block 304. The determined plan is designated as the query plan to execute. The process may flow to block 320, where the designated query plan is executed.

If, at decision block 307, it is determined to not produce a new query plan based on the new query, the process may flow to block 322. At block 322, the stored query plan found at block 304 and determined to be the lowest cost plan is designated as the query plan to execute. The process may flow to block 320, where the designated query plan is executed.

In various implementations, a number of variations of process 300 may be performed. For example, the actions of blocks 308 and 314, or a portion thereof, may be performed after block 302 and before block 304. A parse tree or a bound tree may be used to perform the search of QP storage. These actions then do not need to be performed again upon reaching block 308 or 314, if one is reached. In one implementation, the action of searching QP storage at block 304 may be performed concurrently with at least some of the actions of parsing, binding, or optimizing, at blocks 314 and 316. The determination of block 318 may then be performed based on the new plan and a stored plan, if the latter is found.

Though not illustrated in FIG. 3A, in one embodiment, a newly produced query plan is stored in QP storage. In one embodiment, a newly produced plan is selectively stored in QP storage. This may be based on a frequency of receiving an equivalent query, a length or complexity of a query plan, an importance of a query, or other factors as may be configured.

FIG. 3B illustrates process 350, which is a variation of process 300, as described above. In the illustrated example embodiment, process 350 includes blocks with reference numbers equal to like reference numbers in process 300. In one embodiment, the actions of each of these blocks may be similar or the same as for the corresponding block of process 300, and the descriptions with respect to process 300 may apply to the corresponding block of process 350, though the process flow may differ.

In the illustrated embodiment of process 350, at block 302, an SQL query is received. The process may flow to block 308, where parsing and binding is performed, as described herein. The process may flow to block 310, where optimization is performed, producing a “new” query plan. The process may flow to decision block 330, where a determination is made of whether to search QP storage for a stored query plan that may match the new query. This determination may be made on one or more of a number of factors. The factors may include a system configuration, a determination of the cost of the new query plan, a determination of the certainty of the cost estimate for the new query plan, or other factors.

If it is determined to not search the QP storage, the process may flow to block 312, where the new query plan is designated to be executed. The process may flow to block 320, where the designated query plan (the new query plan) is executed.

If, at decision block 330, it is determined to search the QP storage, the process may flow to block 304, where the QP storage is searched, as described herein. The process may flow to decision block 306, where a determination is made of whether a sufficient stored query plan has been found. If one has not been found, the process may flow to block 312, and continue as described above.

If, at decision block 306, it is determined that a sufficient stored query plan is found, the process may flow to block 318, where a determination is made of whether to use the new query plan or the stored query plan found and determined to be the lowest cost query plan at block 304. The determined plan is designated as the query plan to execute. The process may flow to block 320, where the designated query plan is executed.

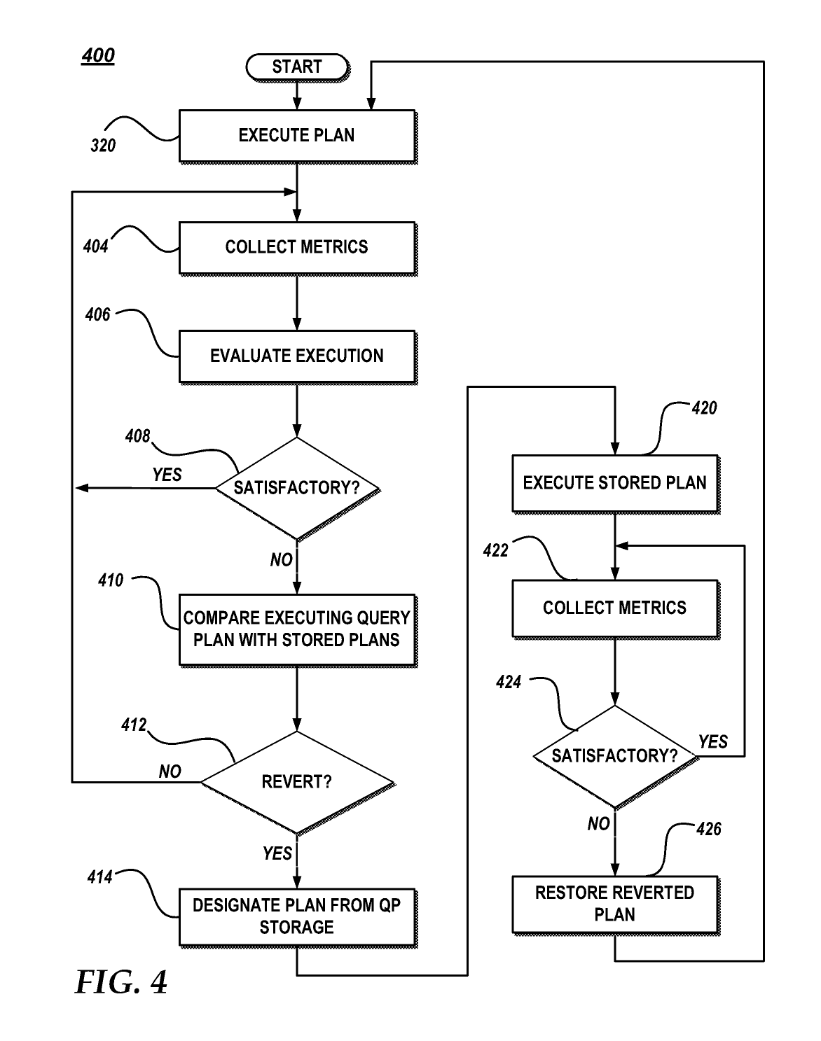

FIG. 4 is a flow diagram of a process 400 of executing a query, in an example embodiment. In one embodiment, at least a portion of the actions of process 400 are performed by query processing system 200, or components thereof.

The illustrated portions of process 400 may be initiated at block 320, in which a query plan is executed. The actions of block 320 may be the same actions as block 320 of FIGS. 3A-B, and thus process 400 may be viewed as a continuation of processes 300 or 350, though in some embodiments, process 400 may be independent of the latter processes. As discussed herein, the query plan being executed at block 320 may be the new query plan produced at block 310 or 316 of process 300 or 350, or it may be a query plan retrieved from QP storage at block 304. The term “current” query plan is used herein to refer to the query plan currently being executed.

The actions of block 320 do not indicate that a plan execution is performed and completed within block 320. That is, block 320 may indicate execution of a portion of the current query plan, and process 400 may flow to block 404 at a point in which the query plan is partially executed. In one embodiment, execution of the query plan at block 402 may continue concurrently with actions of block 404 and other blocks of process 400. In one embodiment, the actions of at least some of the blocks 404-412 may be performed concurrently with execution of a query plan at block 320.

At block 404, metrics relating to execution of the current query plan may be collected. As discussed herein, the metrics may include execution time, processor time, database, system, or environment metrics, or other metrics. In one implementation, at least a portion of the actions of block 404 may be performed by metrics collector 224 (FIG. 2).

The process may flow to block 406, where the execution of the current query plan is evaluated. In one embodiment, this may include comparing at least some collected metrics with expectations associated with the current plan. The evaluation may include a consideration of database, system, or environmental factors. For example, an execution may be proceeding slower than expected, but heavy processor usage by other processes may account for the difference. In one embodiment, the actions of block 406 include a consideration of various factors, to determine a difference with expectations and an amount to which a difference may be attributed to the current query plan. In one embodiment, a specified tolerance is considered, which serves as a threshold to determine whether a difference is great enough to consider the current execution unsatisfactory. In one embodiment, the determination may consider an amount of time or a frequency of which the current query is executed. For example, a query that is infrequently executed may have a higher corresponding tolerance than one that is frequently executed.

The process may flow to decision block 408, where a determination is made of whether the execution of the current plan is satisfactory, based on the evaluation of block 406. If it is considered satisfactory, the process may loop back to block 404, where additional metrics may be collected while the plan continues to execute. Though not illustrated in FIG. 4, in one implementation, the process may not perform additional evaluations, or perform a limited number of evaluations. After that, the execution may be allowed to continue without further evaluations. In one embodiment, the number of evaluations may be limited by the extent to which the current execution has performed, as measured in clock time, processor time, percentage of query plan completion, or another measurement. In one embodiment, an administrator may specify a number of iterations that may be performed, or whether to not limit the number. For example, if a particular query is important or used frequently, an administrator may specify a high number of iterations, in order to find a lowest cost query plan based on available data, configured criteria, and heuristics employed.

If, at decision block 408, the execution of the current query plan is determined to be unsatisfactory, or if the execution of the query plan has completed, the process may flow to block 410, where a comparison with stored query plans matching the current query may be performed. This comparison may consider metrics associated with each of the stored query plans under consideration. This comparison may include logic similar to the determination of a query plan to use in block 318 of FIG. 3, as discussed herein. However, the comparison of block 410 may have additional metrics to consider, as well as other data, such as database, system, or environmental metrics.

The process may flow to decision block 412, where a determination is made of whether to revert to a stored query plan is made, based on the comparison of block 410. As discussed with respect to block 406 and decision block 408, the determination of decision block 412 may consider a specified tolerance, the extent to which the current execution has performed, or other factors. As discussed herein, metrics corresponding with stored query plans may be aged, such that comparison with the stored plans and a determination of whether to revert may consider the age of various metrics.

If, at decision block 412, it is determined to not revert to a stored query plan and the execution has not completed, the process may loop back to block 404. As discussed with respect to the looping back from decision block 408, in various embodiments, the number of times that the process loops back may be limited to zero or more times.

If it is determined to revert the current plan, the current plan may be marked as reverted in QP storage 222. In a future compilation, optimizer 212 may use this information to avoid selecting the marked plan. If it is determined to revert to a stored query plan, the process may flow to block 414, where a stored query plan is designated to be the current query plan. The process may flow to block 420, where execution of the newly designated query plan may begin.

The process may flow from block 420 to block 422, where metrics of the current execution may be collected. Similar to the concurrency discussed with respect to block 402, the execution of block 420 may be performed concurrently with the actions of blocks 422-424.

The process may flow to decision block 424, where a determination is made of whether the current execution is satisfactory. In some implementations, this may consider whether the current execution is an improvement over the prior execution of the reverted plan, though an approximately equivalent execution may also be considered satisfactory. The determination of decision block 424 may include any of the actions and consider any of the factors discussed with respect to blocks 406, 408, or 412, or other factors.

If the current execution is considered satisfactory and has not completed, the process may loop back to block 422, where additional metrics may be collected. As discussed with respect to the back loops from decision blocks 408 and 412, the number of times that process 400 may loop back from decision block 424 may be limited to zero or more times.

If the current execution is not considered satisfactory, the process may flow to block 426, where the reverted plan may be restored. This may include stopping the current execution and designating the reverted plan as the plan to execute. Restoring a previously reverted plan is referred to as “rolling back” the previously reverted plan. The process may flow back to block 402, where execution of the reverted plan begins.

In one embodiment, portions of the illustrated blocks of process 400 are performed with respect to a query that has completed execution. Metrics of the completed execution may be evaluated, and a determination made of whether the plan should be disfavored in a subsequent equivalent query. If so, the plan may be marked in QP storage, as for a reverted plan. In a subsequent query processing, optimizer 212 may use this information to avoid selecting the marked plan.

Portions of process 400 may be used to test a query plan prior to use in production. In one such use, a new query plan may be executed, and metrics may be collected. The execution, or partial execution may be evaluated or compared against stored query plans. A determination that the new plan is unsatisfactory, or would be reverted, serves as an indication that this is not a desirable query plan. The plan may be stored in QP storage 222, with collected metrics, and marked as a reverted plan. In a future compilation, optimizer 212 may use this information to avoid selecting the marked plan.

In one environment, a new query plan may be executed on a test server. In one environment, the new query plan may be executed on a production server using techniques to avoid changes to the database. An administrator may specify that a number of query plans are to be evaluated for a particular query, in order to determine a lowest cost plan, based on configured criteria, heuristics employed, and available data. In one embodiment, a set of query plans matching a specified query may be retrieved from QP storage 222. Each one may be executed, with metrics collected for each one. The lowest cost query plan may be determined and marked as such, for use in subsequent executions of the query. As used herein, the term “lowest cost” is a relative term, and is based on an implementation, configuration, and data. Different implementations may select different query plans as having the lowest cost.

In one variation of process 400, the process may flow from block 414 to block 320, enabling the process to revert a second time to a stored query plan other than the reverted plan. In one embodiment, process 400, or portions thereof, are performed by query processing system 200. In one embodiment, the process is performed automatically, without administrator actions. Thus, the process serves as an automatic correction mechanism, in which one or more decisions made by query processing system 200 may be automatically corrected and, if the correction is determined to be incorrect, restored back to a configuration prior to the correction.

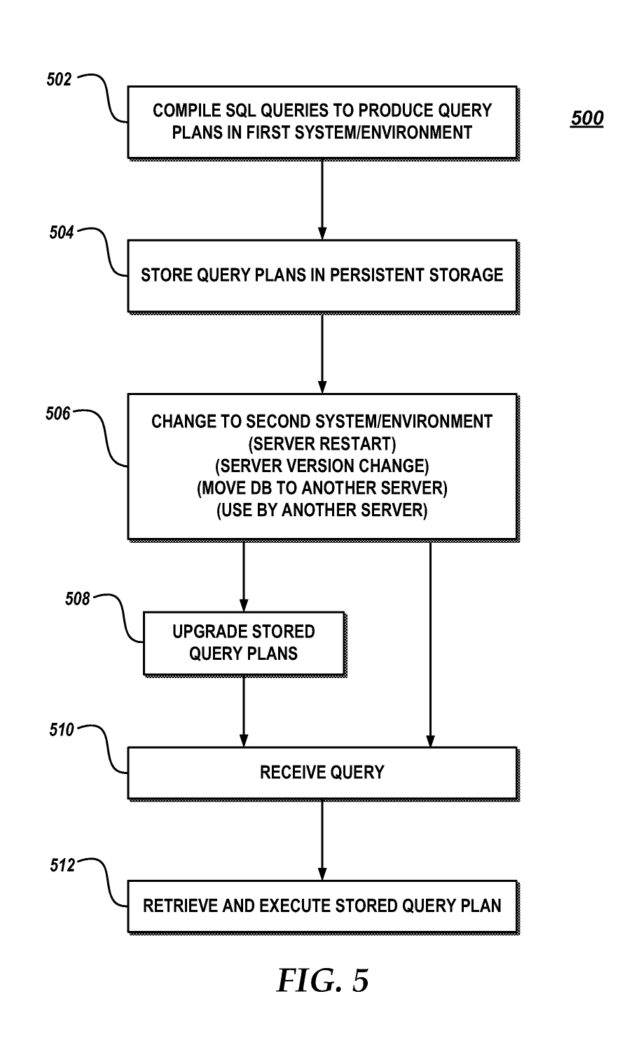

FIG. 5 is a flow diagram illustrating a process 500 of using stored query plans in a changed context, in an example embodiment. In one embodiment, at least a portion of the actions of process 500 are performed by query processing system 200, or components thereof.

The illustrated portions of process 500 may be initiated at block 502, in which one or more queries are compiled to produce one or more query plans, in a first context. The process may flow to block 504, where the one or more query plans are stored in a persistent storage, such as QP storage 222 of FIG. 2. At least a portion of the mechanisms of compiling a query, producing a query plan, and storing the query plan, as described herein, may be used.

The process may flow to block 506, where a change to a second context may be made. The change may include one or more types of changes, some of which are listed in block 506. One such change may be a server restart. Another type of change is a change of the server version. This may include an update of database software or related software. Another type of change is a move of the database to another server. This may include a move to a test server, a move from a test server to a production server, a move from one production server to another production server, or any other type of server change. In one implementation, some types of database schema changes may allow use of a stored query plan as described herein.

In some types of context changes, upgrades of query plans may be performed. For example, a server update may work with query plans having a different format than at least some of the stored query plans. In one embodiment, each query plan is stored with a corresponding version identifier. When a system update occurs, QP storage 222 may be searched for query plans with versions that are to be updated. Each of these query plans may be updated into a version corresponding to the new system version, and stored back into QP storage 222. As illustrated in FIG. 5, process 500 may flow from block 506 to block 508, where query plan updates are performed. In one embodiment, a query plan may be updated by changing its format without recompiling the query. In one embodiment, a program component that is associated with the new context may be used to perform the update.

For some context changes, process 500 may flow from block 506 to block 510, without performing query plan updates. In some implementations, a query plan update may be performed at a different time. For example, an update may be performed “on demand.” That is, at a time when a stored query plan is determined to be a query plan to execute, it may be updated at that time.

The process may flow to block 510, where a query is received in the second context. The process may flow to block 512, where a stored query plan is retrieved from QP storage and executed.

Another type of context change may be a use of the query plans by another server. For example, as discussed herein, data server 110 of FIG. 1 may be implemented by multiple servers. The multiple servers may share a common QP storage 222. In such an environment, a query may be compiled and stored by a first server. A second server may subsequently receive an equivalent query and retrieve the query plan from the common QP storage 222.

Process 500 may be performed automatically, without intervention by an administrator. In one embodiment, query processing system 200 may include logic to recognize a configuration in which stored query plans have a version that does not match a system version. Process 500 or a portion thereof may be automatically initiated in order to update stored query plans without actions by an administrator.

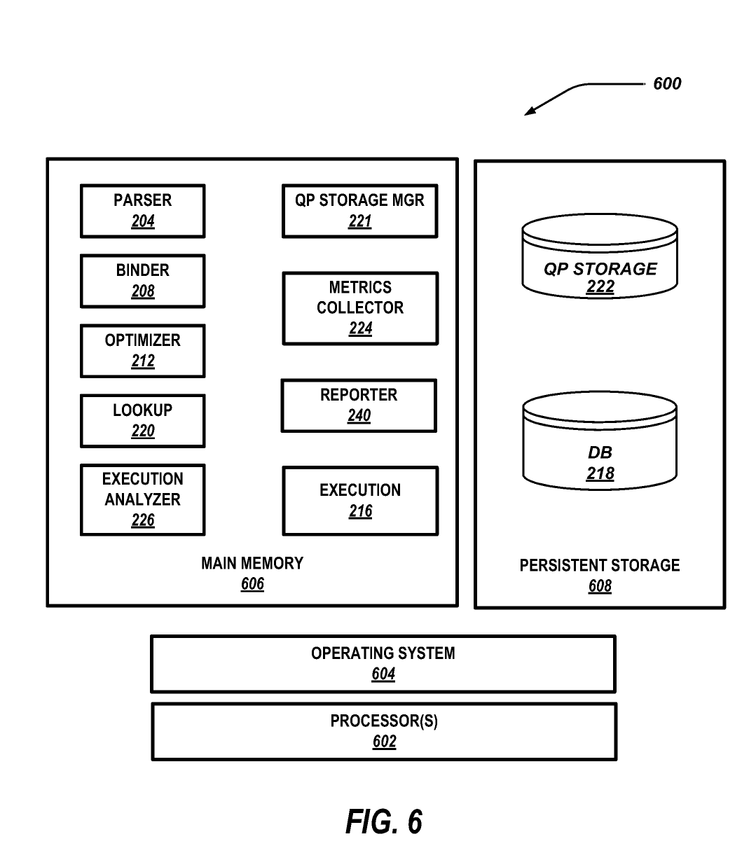

FIG. 6 is a block diagram illustrating an example embodiment of a computing system 600 that may be employed to implement data server 110, query processing system 200, or portions thereof. In various embodiments, computing system 600 may be implemented with one or more servers, other computing devices, or storage devices configured in a variety of ways.

As illustrated, computing system 600 includes one or more processors 602 that perform actions to execute instructions of various computer programs. In one configuration, processors 602 may include one or more central processing units, one or more processor cores, one or more ASICs, or other hardware processing components and related program logic. The illustrated embodiment includes operating system 604, which may be a general or special purpose operating system. Computing system 600 may also include a network communications unit, which performs actions to send or receive messages or signals to remote devices across a network.

In the illustrated embodiment, computing system 600 also includes main memory 606. In one embodiment, main memory 606 is a volatile memory, such as dynamic random access (DRAM) memory. In the illustrated embodiment, main memory has system components stored thereon, including parser 204, binder 208, optimizer 212, execution component 216, QP storage manager 221, lookup component 220, metrics collector 224, execution analyzer 226, and reporter 240.

The illustrated embodiment of computing system 600 further includes persistent storage 608, which is a non-volatile storage medium. This may include one or more disk drives, flash memory, optical storage mechanisms, or any other type of non-volatile memory.

It will be understood that each block of the flowchart illustrations of FIGS. 3A-B, 4, and 5, and combinations of blocks in the flowchart illustrations, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. In a query processing system, a computer-based method comprising:
a) maintaining a plurality of stored query plans in a persistent storage; and
b) in response to receiving a query, performing actions including:
i) based on the stored query plans, determining whether to produce a new query plan based on the query;
ii) selectively designating a stored query plan to be a first query plan;
iii) executing the first query plan;
iv) selectively reverting execution of the first query plan to a second query plan of the stored query plans, based on one or more metrics corresponding to the execution of the first query plan.

2. The computer-based method of claim 1, further comprising:
a) producing the new query plan based on the query;
b) designating the new query plan to be the first query plan;
c) if the execution of the first query plan is reverted to the second query plan, storing configuration data indicative of the reversion in the persistent storage; and
d) in response to a subsequent query, determining a corresponding query plan based on the configuration data indicative of the reversion.

3. The computer-based method of claim 1, further comprising:
a) producing the new query plan based on the query;
b) designating the new query plan to be the first query plan;
c) if the execution of the first query plan is reverted to the second query plan, storing configuration data indicative of the reversion in the persistent storage; and
d) compiling a subsequent query to produce a corresponding query plan based on the configuration data indicative of the reversion.

4. The computer-based method of claim 1, further comprising producing a new query plan based on the query and on data associated with one or more previously executed query plans that correspond to the query.

5. The computer-based method of claim 1, further comprising storing the one or more metrics in logical groupings based on an age corresponding to each metric, selectively designating the stored query plan based on the age corresponding to each metric.

6. The computer-based method of claim 1, further comprising storing the plurality of stored query plans prior to a restart of the query processing system, and receiving the query after the restart.

7. A computer-readable storage medium comprising computer program instructions for processing queries, the program instructions executable by a processor in a computing device to perform actions including:
a) compiling a plurality of queries to produce a plurality of query plans;
b) storing the plurality of query plans in a persistent storage;
c) in response to receiving a new query:
i) selectively designating a stored query plan of the plurality of stored query plans as a first query plan to execute;
ii) selectively optimizing the new query to produce a new query plan;
iii) if a new query plan is produced, selectively designating the new query plan as the first query plan to execute;
iv) executing the designated query plan;
v) collecting one or more metrics based on executing the designated query plan; and
vi) automatically determining whether to revert to a second query plan and execute the second query plan, based on the one or more metrics;

8. The computer-readable storage medium of claim 7, the actions further comprising:
a) designating the new query plan as the first query plan; and
b) determining to revert to the stored query plan and execute the stored query plan.

9. The computer-readable storage medium of claim 7, the actions further comprising:
a) designating the new query plan as the first query plan;
b) determining to revert to the stored query plan and execute the stored query plan; and
c) automatically determining whether to roll back to the first query plan and execute the first query plan, based on executing the second query plan.

10. The computer-readable storage medium of claim 7, the actions further comprising:
a) after storing the plurality of query plans, changing a context in which the designated query plan is executed; and
b) after changing the context, designating the stored query plan as the first query plan;
changing a context comprising at least one of restarting the computing device or transferring the stored query plans to a second computing device.

11. The computer-readable storage medium of claim 7, the actions further comprising:
a) after storing the plurality of query plans, updating an execution software component that executes query plans;
b) updating the stored query plans to conform to the updated execution software component; and
c) executing one or more of the updated stored query plans.

12. The computer-readable storage medium of claim 7, the actions further comprising selectively storing the new query plan in the persistent storage, based on a frequency of receiving the new query.

13. The computer-readable storage medium of claim 7, the actions further comprising transferring the stored query plans to another computing device and executing, on the other computing device, one or more query plans of the plurality of query plans stored in the persistent storage.

14. The computer-readable storage medium of claim 7, the actions further comprising storing the one or more metrics in logical groupings based on an age corresponding to each metric, selectively designating the stored query plan based on the age corresponding to each metric.

15. A computer-based query processing system, comprising:
a) an optimizer that produces query plans based on representations of queries;
b) a query plan storage manager that stores the produced query plans in a persistent storage;
c) determining means for, in response to receiving a new query, determining a first query plan to execute, based on the stored query plans in the persistent store;
d) an execution component that executes the first query plan; and
e) means for automatically evaluating the execution of the determined query plan and determining whether to revert to a second query plan of the stored query plans;
the execution component selectively executing the second query plan based on the determining whether to revert.

16. The computer-based query processing system of claim 15, further comprising means for automatically evaluating the execution of the second query plan and selectively executes the first query plan based on the evaluation of the second query plan execution.

17. The computer-based query processing system of claim 15, further comprising a reporter that produces a report based on the stored query plans and associated metrics to facilitate debugging or configuration of the system.

18. The computer-based query processing system of claim 15, further comprising a computing device, the optimizer and determining means executing on the computing device, the query plan persistent storage storing the produced query plans prior to reboot of the computing device, the determining means determining the first query plan after the reboot of the computing device.

19. The computer-based query processing system of claim 15, further comprising an update component that changes a format of at least some query plans stored in the query plan persistent storage to enable execution of the at least some query plans after the computer-based query processing system is updated to a new version.

20. The computer-based query processing system of claim 15, further comprising data collection means for collecting metrics corresponding to the execution of query plans and storing the metrics in the persistent storage to enable the determining means to determine a first query plan based on the collected metrics.
